(19) United States
(12) Patent Application Publication
(10) Pub. No.: US 2008/0289344 A1
(43) Pub. Date: Nov. 27, 2008

(54) Transcritical Cooling Systems

(76) Inventors: Antonie Bonte, Amersfoort (NL); Jean Paul Leenders, Rosmalen (NL)

Correspondence Address: CHRISTOPHER & WEISBERG, P.A., 200 EAST LAS OLAS BOULEVARD, SUITE 2040, FORT LAUDERDALE, FL, 33301, US

(21) Appl. No.: 11/792,204

(22) PCT Filed: Jul. 25, 2005
(86) PCT No.: PCT/NL05/00542

§ 371 Date: Jul. 28, 2008

(30) Foreign Application Priority Data
Jul. 26, 2004 (NL) 1026728

(51) Int. Cl. C09K 5/04; F25B 1/00; F25B 39/02; F25B 41/04

(52) U.S. Cl. 62/114; 62/228.3; 62/525; 62/222

(57) ABSTRACT

The present invention concerns a method for improving the efficiency of a transcritical cooling installation and the installation itself.

### BRIEF DESCRIPTION OF THE INVENTION

The present invention relates to a method for optimising the efficiency of a transcritical cooling installation, and the installation itself.

### BACKGROUND OF THE INVENTION

Because of the adverse effects on the environment of refrigerants consisting of halogenated hydrocarbons or NH₃, recent years saw a revival of the “old-fashioned’ refrigerant CO₂. Under certain circumstances this has certain disadvantages. These can however be overcome by allowing the cooling cycle to be run transcritically, i.e. above as well as below the critical temperature. An example is the process described in U.S. Pat. No. 4,205,532. In a lot of literature attention is paid to the efficiency of the cooling process (COP, coefficient of performance) at full load. However often the COP is not only important at full load but also at partial load. This applies in particular to the cooling installations in the air conditioning industry and in particular for air treatment units.

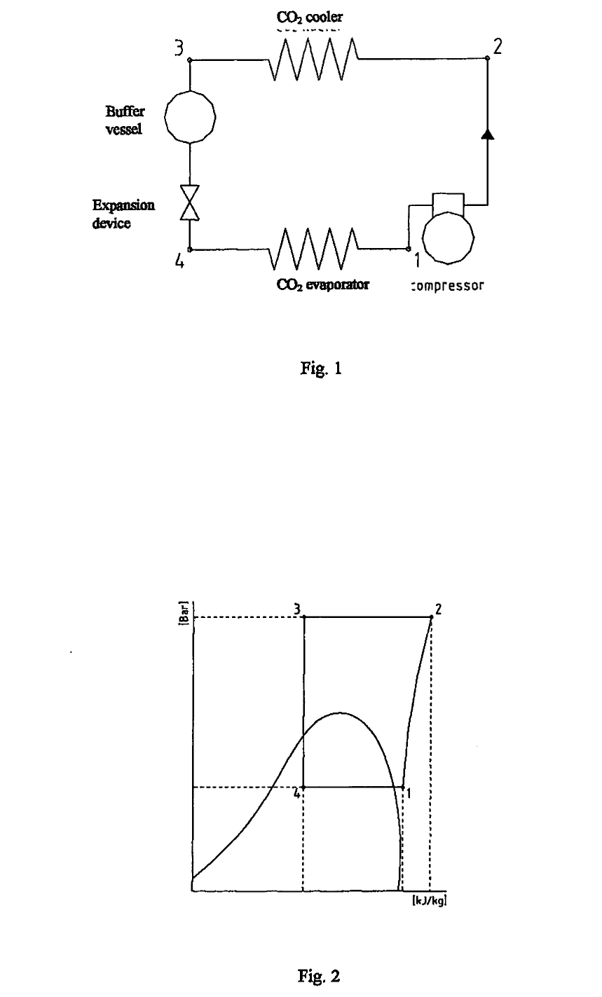

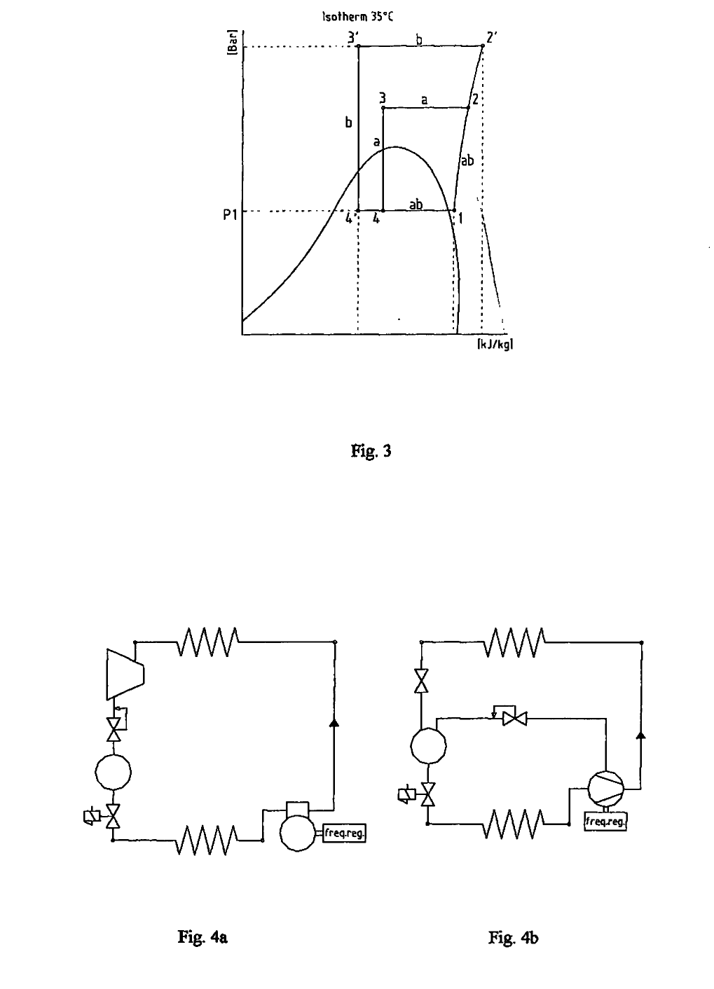

A simple cooling cycle with. CO₂ as a refrigerant is indicated in FIG. 1 and the corresponding mollier diagram in FIG. 2.

In FIG. 1 the following main components can be discerned:
Compressor
CO₂ cooler
Expansion device
CO₂ evaporator.

The compressor sucks the CO₂ gas from the CO₂ evaporator at suction pressure Po(1) and increases the pressure to the discharge pressure Pd (2). In the CO₂ cooler the CO₂ gas is cooled from the discharge gas temperature (2) to temperature (3). Temperature (3) is a number of degrees (e.g. 5 K) above the entrance temperature of the medium with which the CO₂ is cooled. After cooling the CO₂ passes the high-pressure buffer vessel and the pressure of the CO₂ is lowered from the discharge pressure to the suction pressure (4) by means of an expansion device. In the CO₂ evaporator the liquid CO₂ is evaporated, whereby the expansion devices assures that the CO₂ gas leaves the evaporator superheated (1) (a couple of degrees e.g. 7 K above the corresponding evaporation pressure P₀). Points (1), (2), (3) and (4) are also indicated in the mollier diagram.

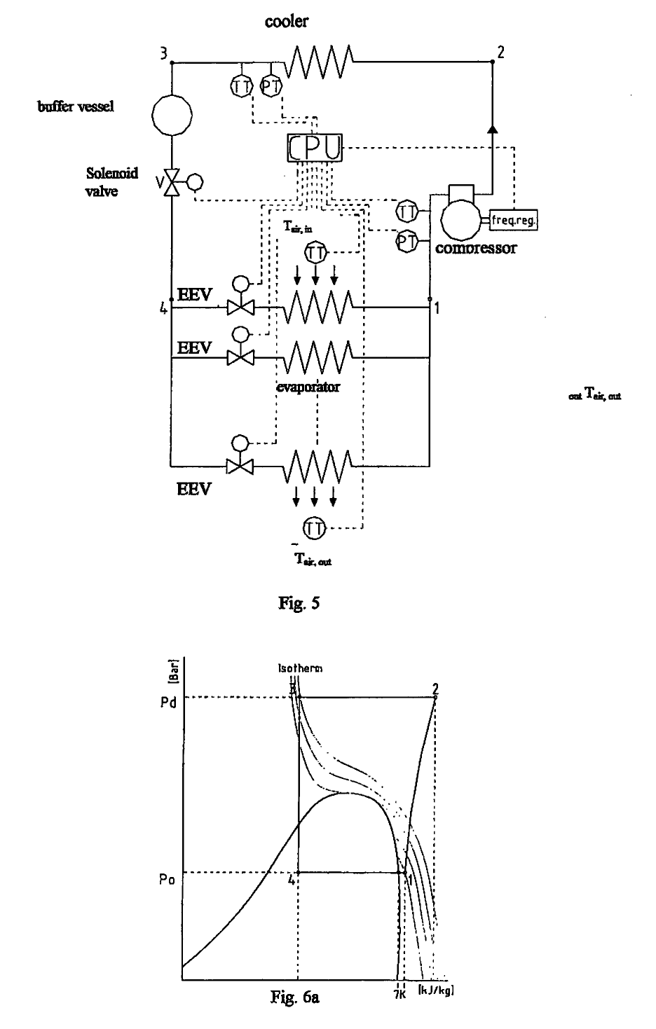

Because of the particular course of the isotherms above the critical point different laws apply to the COP of transcritical CO₂ installations compared to a subcritical installation. This will be clarified by means of FIG. 3. In FIG. 3 two cyclic processes are represented, processes a and b. Process a takes place at a suction pressure corresponding to an evaporation temperature of 10° C. and a discharge pressure of 80 bar. In both processes the CO₂ is cooled down to 35° C. at present discharge pressures. As a result of the course of the isotherms above the critical point and the course of the isentropes the COP of process b is bigger than that of process a. Although process b requires more energy, i.e. h_{2′}-h₂, but the enthalpy of the cooled CO₂ of process b in the CO₂ cooler (h₃′) is considerably lower than that of process a (h₃). As a result of this latter effect process b provides more cooling and a higher COP than process a. The conclusion drawn from the above is that contrary to subcritical processes for transcritical CO₂ processes applies that under certain circumstances transcritical CO₂ processes have a higher COP at higher pressure ratios (Pd/Po). For all refrigerants in the subcritical range applies that under equivalent circumstances the COP decreases with higher pressure ratios.

For transcritical CO₂ installations the following aspects are important in order to achieve a maximum COP under partial load conditions:
1. At partial load the discharge pressure should not be allowed to drop too far. Too large a drop of the discharge pressure as a result of partial load of the cooling installation can decrease the COP. After all, the isotherms bend to the right with a lower pressure whereas the isentropes take a steep course.
2. with an increase in the temperature of the cooling medium with which CO₂ is cooled in the CO₃ cooler it can be necessary to increase the discharge pressure of the installation in order to achieve a better COP. This applies both at full load and partial load.

In order to increase the thermodynamic efficiency (COP) of the system it is important to control the pressure in the high pressure part of the cooling cycle. The prior art supplies a number of methods for this. E.g. WO-A-97/27437 and WO-A-94/14016 propose to do this by varying the refrigerant charge of the system. However this does not achieve the desired improvement in the efficiency of the installation but only serves to avoid pressure problems during inactivity of the installation at high ambient temperatures.

Because of the fact that in CO₂ installations the evaporation, like with halogenated hydrocarbons and NH₃ takes place in the co-existence area, the same rules apply regarding the variation of the evaporation temperature.

In order to improve the COP at partial load the following operational conditions should be aimed for:
1. the evaporation temperature should be as close as possible to the target temperature of the medium to be cooled, e.g. air. According to Carnot's formula the evaporation temperature is very important for the COP. The higher the evaporation temperature, and the smaller the difference between evaporation and condensation temperature, the higher the COP.
2. the pressure in the CO₂ cooler should not be allowed to drop too much. As a result of the course of the isotherms of CO₂ above the critical point and the course of the isentropes the COP can decrease with a lower discharge pressure under certain circumstances.

Ad 1. the increase of the evaporation temperature at partial load is countered by a reduction of the mass flow density, as a result of which the internal heat transfer coefficient (α) decreases. As a result the evaporation temperature increases less strongly than would be expected on the basis of the logarithmical temperature difference.

Ad. 2 at partial load the discharge pressure will decrease for two reasons:
1 at partial load the mass flow density of the refrigerant in the evaporator will decrease and as a result the refrigerant content in the liquid phase of the evaporator will increase.
2 As a result of an increase in the suction pressure the amount of refrigerant in the gas phase of the evaporator will increase.

The increase in the amounts of refrigerant in the evaporator is extracted from the high pressure side of the installation as a result of which the discharge pressure at partial load decreases.

### STATE OF THE ART

In various patents and other scientific literature systems are described that superficially are comparable with the system according to the invention:

EP-A-1207361. In this system the pressure of the system is controlled but this is done by means of a valve at the discharge end of one or more cooler circuits. This will not lead to a higher COP because the disconnected circuit fills with the relatively cold CO₂ with a high density. As a result the pressure will actually decrease in the cooler because less CO₂ is available in the other circuits. According to the ideal gasses law the pressure will decrease in such cases.

Hafner et al, IIR-Gustav Lorentzen Conference on natural working fluids. Proceedings, XX, XX Jun. 2,1998, pp 335-345

The system described here consists of two separate evaporators. These are not controlled via superheating but directly control the pressure on the high-pressure side. The purpose of this system is not to optimise the COP but to easily and quickly vary the cooling/heating capacity.

US-A-2004123624. This is a system with two evaporators that work at different pressures. It is described that the pressure at the high-pressure side can be optimised via valves to achieve an optimum COP. However the two evaporators serve different spaces or parts of spaces.

U.S. Pat. No. 6,095,379. This system also has two evaporators and here too the system is controlled by directly opening or closing a valve.

US-A-2001037653 In one system two evaporators are used, each with its own evaporation pressure. One evaporator has an adjustable valve, the other evaporator uses a turbine. Both systems have their own compressor. Also a system with a turbine and an adjustable expansion valve is described.

All solutions mentioned above do not aim—nor are capable of—achieving and maintaining an optimum COP. However for reasons of energy economy this is desirable.

### DESCRIPTION OF THE INVENTION

The purpose of the present invention is to optimise the COP of a transcritical installation at partial load. In order to achieve this the invention proposes an intelligent control of the installation, characterised in that the intelligent control system optimises
a) the number of circuits in use in the evaporator and
b) the suction pressure of the compressor
   in such a way that as high a COP as possible is achieved, both at partial load of the cooling installation and at varying medium temperatures for cooling the CO₂ in the CO₂ cooler. A further aspect of the present invention is that the COP can be further improved by including an expansion turbine in the system, possibly in cooperation with the electronic expansion valves.

Another aspect of the present invention is that the COP can be further improved by optimising the difference between discharge and suction pressure by including an expansion vessel with an adjustable pressure in the system, connected to a superfeed in case of a screw compressor, and in case of multi-stage compression, set at one of the intermediate pressures.

Furthermore the invention offers a transcritically working cooling installation, comprising a compressor, cooler, one or more temperature transmitters, one or more pressure transmitters, one or more valves, a capacity control of the compressor (frequency control, cylinder or control valve) characterised in that it further comprises
a central processing unit (CPU);
an evaporator composed of at least two circuits, that can be individually closed by means of an electronic expansion valve (EEV)
   that are connected in such a way that the values measured by the temperature transmitters and the pressure transmitters are processed by the central processing unit into control signals for the electronic expansion valves and the capacity control of the compressors in order to maintain an optimum COP both at full load and partial load. Furthermore the invention offers a cooling installation as described in the previous paragraph, characterised in that it further comprises a buffer vessel with an adjustable pressure.

An essential difference with the systems of the state of the art is that there separate evaporators are used for different spaces or parts of spaces (in order to achieve different temperatures in each), where as the invention uses one evaporator with several circuits for one space.

This fact alone makes it impossible to optimise the COP with the systems of the state of the art, because the different processes are going on in different evaporators under different circumstances.

Another aspect is that in the systems of the state of the art the superheating is a function of the pressure, and not the other way round as in the invention. By taking the superheating as the variable to be controlled it is possible to set the other variables in the system (pressure, compressor performance) in such a way that an optimum condition in terms of energy consumption and efficiency is always maintained.

The invention will be further explained by means of the following figures in which

FIG. 1 describes a simple cooling cycle,

FIG. 2 shows the corresponding mollier diagram of this cooling cycle at foil load (points 1,2,3,4)

FIG. 3 shows the graph corresponding to tables 1a and 1b,

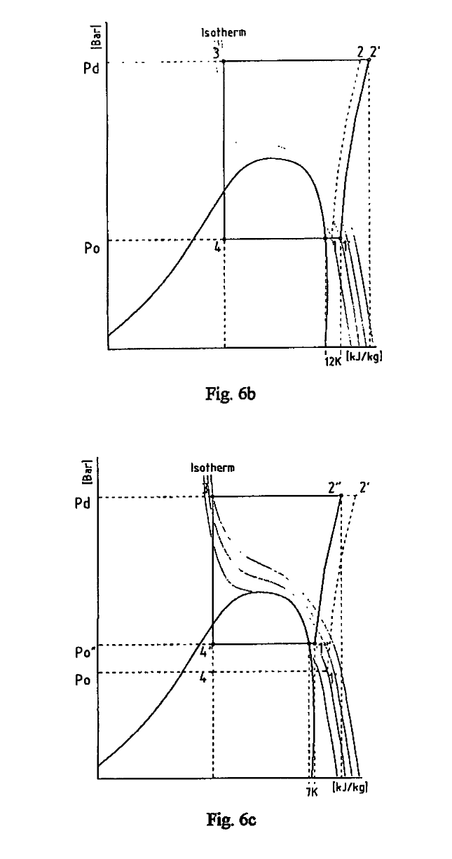

FIG. 4a shows a circuit including a turbine

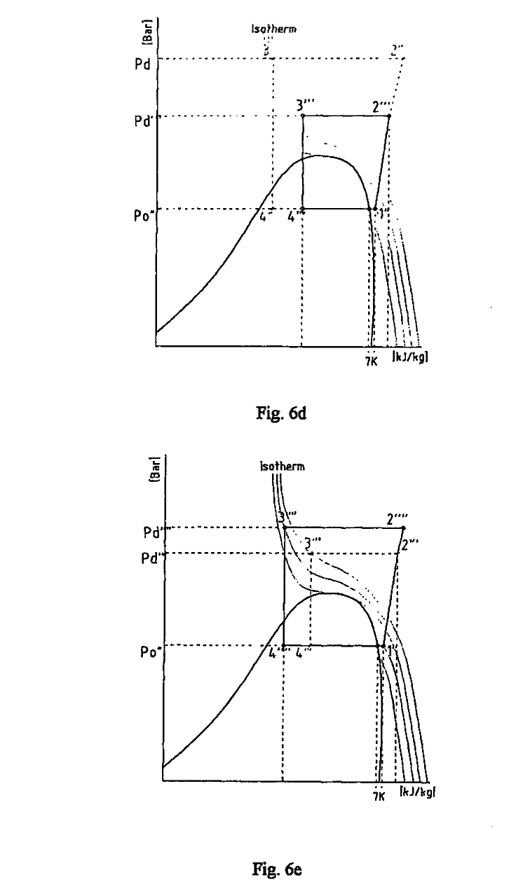

FIG. 4b shows a circuit with a high-pressure buffer vessel with adjustable intermediate pressure (simplified representation of FIG. 5)

FIG. 5 an installation according to the invention

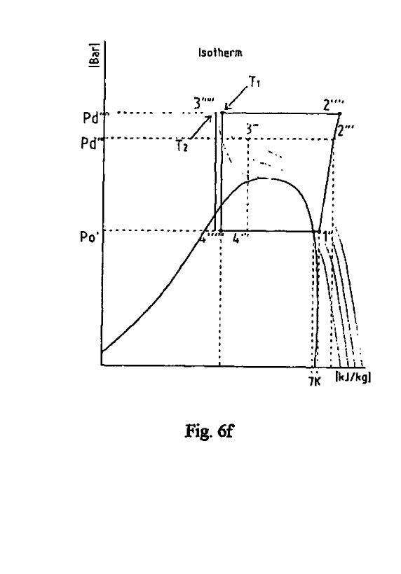

FIG. 6 a-f steps in the control cycle

FIG. 6a full load

FIG. 6b increase of superheating

FIG. 6c increasing the suction pressure

FIG. 6d lowering of the discharge pressure

FIG. 6e disconnecting a circuit

FIG. 6f lower temperature

In these FIGS. the accents (e.g. 3″) have the following meaning

′≡ increased superheating

″≡ desired standard superheating with high suction pressure and lower discharge gas temperature

″′≡ lower discharge pressure

″″≡ higher discharge pressure

″″′≡ reduced load, further cooling

FIG. 5 represents a cooling system according to the invention, in which TT and PT are temperature and pressure transmitters respectively, MK is a solenoid valve, EEV the electronic expansion valves, CPU the central processing unit. By comparing the set values with the values measured by the transmitters the CPU adjusts the position of the EEV, MK and the frequency control in order to achieve the set values.

The starring point is a full load situation as represented in FIG. 6a. When the required cooling capacity decreases the installation will act as follows by means of the control circuit. By means of the electronic expansion valves EEV the desired entry temperature is maintained by extra superheating the refrigerant: point 1 in FIG. 6b has moved to the right (1′). The increased superheating of the refrigerant is reason for the control circuit to increase the suction pressure of the compressor (FIG. 6c) A higher superheating than the setpoint for superheating means that the difference between the temperature of the medium to be cooled and the evaporation temperature is bigger. A higher superheating of the suction gas means that the refrigerant is heated more than is strictly necessary to protect the compressor. This higher superheating can be countered by increasing the suction pressure, which simultaneously increases the evaporation temperature (see fig 6c). Point 1″ has a higher suction pressure and again has a superheating in the order of that under full-load conditions. A higher suction pressure is obtained by reducing the amount of refrigerant flowing through the compressor, e.g. by lowering the number of revolutions or by means of a control valve of the compressor. Because the suction pressure has increased and the evaporator is working at partial load, the amount of refrigerant in the evaporator will increase. This amount is obtained from the high-pressure side by means of the EEV and the high-pressure buffer vessel As a result the discharge pressure drops, see FIG. 6d. As has been explained above this can be disadvantageous to the COP. If the discharge pressure becomes too low, the superheat of a circuit will be increased or a circuit in the evaporator will be disconnected by means of the electronic expansion valve EEV. As a result the decrease in the quantity of CO₂ in the CO₂ cooler will be counteracted, causing the discharge pressure to remain high enough at a higher suction pressure, see FIG. 6e. Because the CO₂ cooler is less charged, the CO₂ is cooled to a lower temperature T₂ instead of T₁, see FIG. 6f.

The result is that a smaller cooling capacity is generated with a higher COP than at full load because
the suction pressure is higher,
the discharge pressure is lower
the CO₂ is cooled down to a temperature that is closer to the inlet temperature of the refrigerant in the cooler.

The above is illustrated by means of a example on the basis of FIG. 3, where the effect on the COP of different pressures in an installation according to the invention is calculated. This calculation is done with the aid of the Coolpack software, developed by the Technical University of Copenhagen, Denmark. The specification of this installation is given below:

Evaporator

Spiralised copper pipe

Pipe pattern: Ø ⅜″* 1 mm (Cu alloy) 40 rows high, 8 rows deep

Fins: 0.3 mm Al

The pipes has been divided over 4 independently controllable circuits

CO₂—gas cooler

The design is similar to that of the evaporator. The circuits are connected in a different way.

Compressor

| | |
|---|---|
| Manufacturer | Mycom |
| No. of cylinders | 2 |
| Power | 25 kW |
| Pd, max | 15 Mpa (150 bar) |
| Ps, max | 7 Mpa (70 bar) |

TABLE 1a
Discharge pressure = 8,000 kPa (80 bar)

| | Temperature | Pressure | Enthalpy | Density |
|---|---|---|---|---|
| Point | (° C.) | (kPa) | (kJ/kg) | (kg/m³) |
| 1 | 15.0 | 4502 | −72.6 | 124.6 |
| 2 | 64.1 | 8000 | −40.9 | 183.4 |
| 3 | 35.0 | 8000 | −154.5 | 419.1 |
| 4 | 10.0 | 4502 | −154.5 | — |

The reference value for the enthalpy is 0 kJ/kg at T = 298.15 K and p = 101.325 kPa

TABLE 1b
Discharge pressure is 10,000 kPa (100 bar)

| | Temperature | Pressure | Enthalpy | Density |
|---|---|---|---|---|
| Point | (° C.) | (kPa) | (kJ/kg) | (kg/m³) |
| 1 | 15.0 | 4502 | −72.6 | 124.6 |
| 2′ | 84.8 | 10000 | −27.4 | 212.0 |
| 3′ | 35.0 | 10000 | −217.4 | 713.5 |
| 4′ | 10.0 | 4502 | −217.4 | — |

The reference value for the enthalpy is 0 kJ/kg at T = 298.15 K and p = 101.325 kPa

TABLE 2
A higher discharge pressure and consequently a
higher pressure ratio yields a higher COP.

| pressure | COP | Enthalpy difference |
|---|---|---|
| 80 bar | 2.58 | 114 |
| 100 bar | 3.20 | 190 |

TABLE 3
Cycle specification

| | 80 bar | 100 bar |
|---|---|---|
| Q_{E} (kW) | 60.000 | 60.000 |
| Q_{GC} (kW) | 83.216 | 78.752 |
| m (kg/s) | 0.7329 | 0.4144 |
| η_{IS} | 0.700 | 0.700 |

From the above h will be apparent to a person skilled in the art that in this way it is possible to maintain an optimum COP under all circumstances, i.e. also at partial load. In other words the installation is working as efficiently as possible under all circumstances. By selecting the superheating as a control value instead of the pressure a situation is achieved in which the pressure of the system is at all times adapted to the targeted condition (temperature) to achieve maximum efficiency. Thus, it will also be appreciated that this cannot be achieved by the systems of the state of the art, where the pressure is adjusted only to achieve a certain ambient temperature under full load, not to run the installation efficiently under other circumstances.

In the above CO₂ has been mentioned as a refrigerant but it will be obvious to the person skilled in the art that the invention can also be used on installations with other refrigerant with a low critical temperature. Also it will be apparent that variants and modifications are possible within the scope of the invention.

1. A transcritically working cooling installation, comprising a compressor, an evaporator, an expansion device, one or more temperature transmitters, one or more pressure transmitter, solenoid valves, a capacity control for the compressors and a refrigerant, wherein
the evaporator includes at least two circuits that are individually controlled by an electronic expansion valve (EEV), and
further comprising a central processing unit (CPU) for processing the signals transmitted by the temperature transmitters and pressure transmitters into control signals for the electronic expansion valves, the solenoid valves and the capacity control of the compressor(s) in order to maintain an optimum coefficient of performance (COP) under both full load and partial load.

2. The installation according to claim 1, wherein the expansion device further compromising a turbine.

3. The installation according to claim 1 further comprising a controllable buffer vessel.

4. A method for controlling a transcritical cooling installation comprising a compressor, an evaporator comprising two or more circuits provided with electronic expansion valves, one or more temperature transmitters, one or more pressure transmitters, one or more valves, a capacity control of the compressor(s), a refrigerant and a central processing unit that are connected in such a way that the signals from the temperature transmitters and the pressure transmitters are processed into control signals for the electronic transmitters and the pressure transmitters are processed into control signals for the electronic expansion valves, the valves and the capacity control of the compressor, wherein
a) using the electronic expansion valves to control the number of circuits in the evaporator, and
b) the suction pressure of the compressor is controlled, such that an optimum coefficient of performance is maintained.

5. The method according to claim 4, wherein a turbine is used for controlling the pressure.

6. The method according to claim 4, wherein a controllable high-pressure buffer vessel is used.

7. The A installation according to claim 1, wherein the refrigerant is CO₂.

8. The method according to claim 4, wherein the refrigerant is CO₂.

9. The method according to claim 4, wherein it is used in air-conditioning, industrial cooling installations and heat pumps.

10. The installation according to claim 2, further comprising a controllable buffer vessel.

11. The method according to claim 6 wherein a controllable high-pressure buffer is used.

12. The installation according to claim 2, wherein the refrigerant is CO₂.

13. The installation according to claim 3, wherein the refrigerant is CO₂.

14. The method according to claim 5, wherein the refrigerant is CO₂.

15. The method according to claim 6, wherein the refrigerant is CO₂.
